(19) United States
(12) Patent Application Publication
(10) Pub. No.: US 2020/0167385 A1
(43) Pub. Date: May 28, 2020

(54) METHOD FOR MANAGING COPYRIGHT OF MUSIC CONTENTS

(71) Applicant: ARTISTS CARD INC., Seongnam-si (KR)

(72) Inventor: Yun Sung JUNG, Seoul (KR)

(73) Assignee: ARTISTS CARD INC., Seongnam-si (KR)

(21) Appl. No.: 16/199,778

(22) Filed: Nov. 26, 2018

(51) Int. Cl. G06F 16/68; G06F 16/38; G06F 16/638

(52) U.S. Cl. CPC G06F 16/686; G06F 16/638; G06F 16/38

(57) ABSTRACT

Disclosed is a method for managing copyright of music contents, includes storing information about copyright owners and performers, storing information about music pieces, storing information about music contents, matching information about the copyright owners with the music pieces stored, matching information about the music pieces stored with the music contents, and matching information about the music contents with information about the performers, receiving selection information about first music content stored in the third database, obtaining information about a music piece matched with the first music content from the second database and obtaining information about the copyright owner matched with the music piece from the first database, providing information about the copyright owner or information about the performer.

### BACKGROUND

Embodiments of the inventive concept described herein relate to a method for managing the copyright of music contents.

A public domain is a concept that includes a copyrighted work of which the copyright has expired, the copyrighted work, which the country holds and which the country determines to release, the copyrighted work donated by the copyright owner for public use, or the like; the public domain means the copyrighted work capable of being freely used by a general user without any burden of the copyright.

The duration of the copyright is determined according to Domestic Copyright Law and International Treaty. When the copyright has expired, it is possible to provide a service using the copyrighted work without paying a copyright fee. Accordingly, methods for providing a service by using the copyrighted work of which the copyright has expired have been developed.

However, the copyright needs to be considered in consideration of Domestic Copyright Law, International Treaty, and the transitional provision according to the amendment of each law and each treaty; in many cases, the copyright needs to be considered in consideration of not only the copyright owner but also a plurality of owners of neighboring rights. Accordingly, it is practically difficult to determine whether the copyright of each copyrighted work has expired.

### SUMMARY

Embodiments of the inventive concept provide a method for managing the copyright of music contents.

The technical objects of the inventive concept are not limited to the above-mentioned ones, and the other unmentioned technical objects will become apparent to those skilled in the art from the following description.

According to an aspect of an embodiment, a method for managing a copyright of music content performed by a server, includes storing information about a name or a death date of each of a copyright owner and a performer in a first database as information about one or more copyright owners and performers, storing information about a title and the name of the copyright owner of a music piece in a second database, as information about one or more music pieces, storing information about the name of the performer, a recording time, a publication time, a published country of the music content in a third database as information about one or more music contents, matching information about the one or more copyright owners stored in the first database with the one or more music pieces stored in the second database, matching information about the one or more music pieces stored in the second database with the one or more music contents stored in the third database, and matching information about the one or more music contents stored in the third database with information about the one or more performers stored in the first database, receiving selection information about first music content stored in the third database, obtaining information about a music piece matched with the first music content from the second database and obtaining information about the copyright owner matched with the music piece from the first database, providing information about the copyright owner or information about the performer, storing the information about the one or more music contents stored in the third database and information about whether each music content is a public domain in a fourth database, and providing information about a remaining time until the first music content becomes the public domain, when the first music content is not the public domain, wherein the providing of the information includes: obtaining a duration of a posthumous copyright of the copyright owner and a duration of a posthumous neighboring right of the performer depending on a transitional provision of Copyright Law and International Treaty, determining the transitional provision to be applied to the first music content depending on a recording time or a publication time of the first music content, determining whether the first music content is the public domain, depending on a death date of each of the copyright owner and the performer, the obtained duration of the copyright, and the obtained duration of the neighboring right, determining whether the first music content is the public domain, depending on a recording time and a publication time of the first music content and the transitional provision, and providing information about whether the first music content is the public domain, which is stored in the fourth database, wherein the determining of whether the first music content is the public domain includes: determining whether the first music content is the public domain, depending on the duration of the copyright and the neighboring right of a country to be applied, wherein the matching further includes: storing a first identifier in the second database and storing a second identifier in the third database, and storing a third identifier in the third database, wherein the first identifier is used to obtain information about the one or more copyright owners matched with the one or more music pieces stored in the second database from the first database, wherein the second identifier is used to obtain information about the one or more music pieces matched with the one or more music contents stored in the third database from the second database, wherein the third identifier is used to obtain information about the one or more performers matched with the one or more music contents stored in the third database from the first database, and wherein the server is configured to: convert a death date of each copyright owner or each performer into a number to store the converted number in the first database for the purpose of calculating whether the copyright or the neighboring right of each copyright owner or each performer expires, wherein the death year is converted into ‘9999’ and stored when the copyright owner or the performer is alive or there is no information, and wherein a unit's place of the death year is substituted and stored with ‘9’, when the unit's place of the death year is incorrect, and convert each recording date or each publication date into a number to store the converted number in the third database for the purpose of calculating whether the neighboring right has expired, wherein a recording date or a publication date is converted and stored into a last date, when the recording date or the publication date has a plurality of periods, and wherein the recording date or the publication date is converted and stored into a last month, when there is no information other than a year.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method for managing copyright of music contents, according to an embodiment;

FIG. 2 is a view illustrating first to third databases, according to an embodiment;

FIG. 3 is a view additionally illustrating a fourth database, according to an embodiment;

FIG. 4 is a table illustrating an example of a first database;

FIG. 5 is a table illustrating an example of a second database;

FIG. 6 is a table illustrating an example of a third database;

FIG. 7 is a view illustrating a method for determining whether each music content is a public domain, according to a disclosed embodiment; and

FIGS. 8 and 9 are tables illustrating an example of a fourth database.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

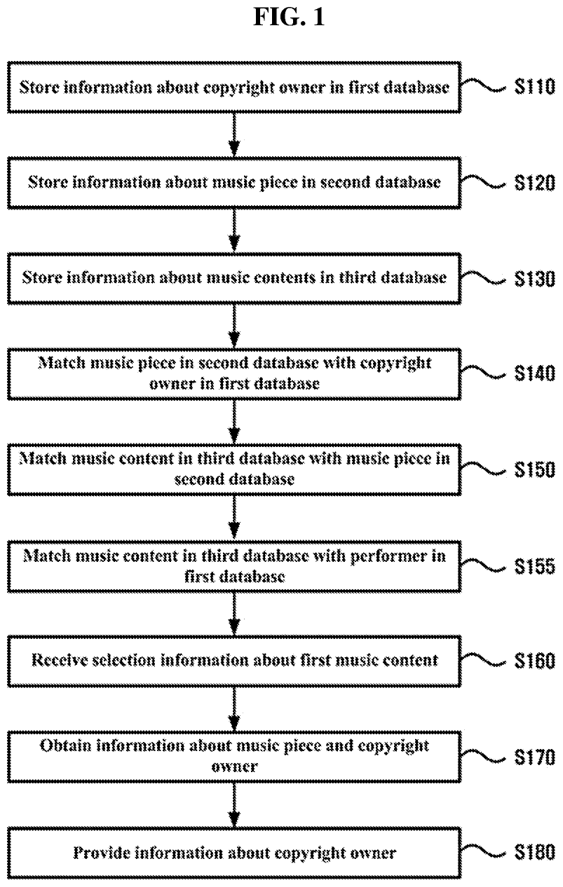

FIG. 1 is a flowchart illustrating a method for managing copyright of music contents, according to an embodiment.

Each of the operations illustrated in FIG. 1 is performed by a server managing the copyright of music contents.

In operation S110, the server stores information about one or more copyright owners in a first database. In the disclosed embodiment, the database means the set of data, which is stored in the server and which is integrally managed for easy use.

In an embodiment, the database is implemented with a data structure such as a table. However, a method in which the database is constructed is not limited.

The information about one or more copyright owners stored in the first database includes the death date of the copyright owner. In addition, information about the name, the date of birth, the nationality, the place of birth, the place of death, and the main activity area (a composer, a lyricist, or the like) of the copyright owner may be stored in the first database.

In an embodiment, the copyright owner means a composer. In the case of a music copyrighted work with lyrics, the copyright owner means a composer and a lyricist.

In an embodiment, the server stores information about one or more performers in the first database. The performer may have the neighboring right in accordance with Copyright Laws or Treaty.

The information about one or more performers stored in the first database includes the death date of a performer. Furthermore, information about the name, the date of birth, the nationality, the place of birth, the place of death, and the main activity area (an instrument, or the like) of the performer may be stored in the first database.

The server may assign the predetermined unique number to information about one or more copyright owners or performers stored in the first database.

In operation S120, the server stores information about one or more music pieces in a second database.

The information about one or more music pieces stored in the second database includes the title of each music piece. Moreover, the information about one or more music pieces stored in the second database includes the name of the copyright owner of each music piece. Also, the information about one or more music pieces stored in the second database further includes detailed information about each music piece.

The server may assign the predetermined unique number to each information about one or more music pieces stored in the second database

In operation S130, the server stores information about one or more music contents in a third database.

In the disclosed embodiment, “music contents” means a sound source in which a “music piece” is recorded. Accordingly, a plurality of different “music contents” may exist with respect to one “music piece”.

The information about one or more music contents stored in the third database includes the title and the performer's name of the music contents. Furthermore, the information about one or more music contents stored in the third database includes information about the recording and publication of each music content.

For example, the information about one or more music contents stored in the third database includes information about the date on which each music content is recorded, the place where each music content is recorded, the date on which each music content is published, the country where each music content is published, and the copyright owner for the publication, and the like.

The server may assign the predetermined unique number to each information about one or more music contents stored in the third database.

In operation S140, the server matches one or more music pieces stored in the second database with one or more copyright owners stored in the first database.

In the case of the music piece, it is common for the name of the copyright owner to be provided together. However, detailed information about the copyright owner may not be provided. Accordingly, the server matches the information about one or more music pieces stored in the second database with the information about one or more copyright owners stored in the first database, by using the copyright owner's name of each music piece.

The server stores, in the second database, an identifier for obtaining the information about one or more copyright owners, which are matched with the one or more music pieces stored in the second database, from the first database. For example, the server stores the unique number in the first database for each of the matched one or more copyright owners, in the second database.

In operation S150, the server matches information about one or more music contents stored in the third database with information about one or more music pieces stored in the second database.

The server matches one or more music contents stored in the third database with one or more music pieces stored in the second database, by using the titles of one or more music contents stored in the third database.

The server stores, in the third database, an identifier for obtaining information about one or more music pieces, which are matched with one or more music contents stored in the third database, from the second database. For example, the server stores the unique number in the second database for each of the matched one or more music pieces, in the third database.

In operation S155, the server matches information about one or more music contents stored in the third database with information about one or more performer stored in the first database.

In the case of the music contents, it is common for the name of the performer to be provided together. However, detailed information about the performer may not be provided. Accordingly, the server matches the information about one or more music contents stored in the third database with the information about one or more performers stored in the first database, by using the performer's name of each music content.

The server stores, in the third database, an identifier for obtaining the information about one or more performers, which are matched with one or more music contents stored in the third database, from the first database. For example, the server stores the unique number in the first database for each of the matched one or more performers, in the third database.

In operation S160, the server receives selection information about first music content stored in the third database.

In an embodiment, the server receives the selection information about the first music content from a user client. In another embodiment, the server receives the selection information about the first music content from a system in another server or the same server.

In operation S170, the server obtains information about the music piece matched with the first music content, from the second database and obtains information about the copyright owner matched with the music piece, from the first database.

In an embodiment, the server obtains information about the music piece from the second database by using the unique number of the music piece stored in the third database. The server obtains information about the copyright owner from the first database by using the unique number of the copyright owner of the music piece, which is included in information about the music piece obtained from the second database.

In operation S180, the server provides the information about the copyright owner; the provided information about the copyright owner includes the death date of the copyright owner.

In addition, the server determines whether the first music content is a public domain, depending on the death date of the copyright owner and Copyright Law and International Treaty and provides the determined information about whether to be the public domain.

Moreover, the server determines whether the first music content is the public domain, depending on the death date of the performer and Copyright Law and International Treaty and provides the determined information about whether to be the public domain.

Furthermore, the server determined whether the first music content is the public domain depending on the recording time and the publication time of the first music content stored in the third database, Copyright Law and International Treaty and provides the determined information about whether to be the public domain.

Furthermore, the server determines whether the copyright and the neighboring right of the first music content expire, depending on the death date of each of the copyright owner and the performer, the recording time and the publication time of the first music content, Copyright Law and International Treaty; when the copyright and the neighboring right of the first music content expire, the server determines that the first music content is the public domain.

When the first music content is not the public domain, the server provides information about the remaining time until the first music content becomes the public domain.

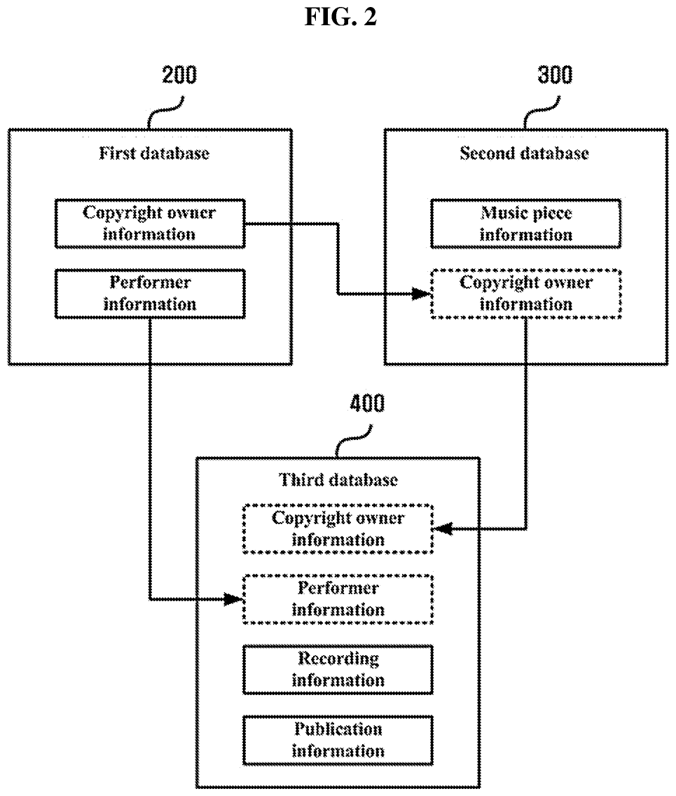

FIG. 2 is a view illustrating first to third databases, according to an embodiment.

A first database 200, a second database 300, and a third database 400, which are illustrated in FIG. 2 may be the set of data stored in a server.

The first database 200, the second database 300, and the third database 400, which are illustrated in FIG. 2, correspond to the first database, the second database, and the third database described with reference to FIG. 1, respectively.

Accordingly, even though omitted with reference to FIG. 2, the description about the first database, the second database, and the third database, which are given with reference to FIG. 1, is applied to the first database, the second database, and the third database, which are illustrated in FIG. 2 below.

Referring to FIG. 2, the relationship between the first database, the second database, and the third database is illustrated.

Copyright owner information is stored in the first database 200. In an embodiment, performer information is stored in the first database 200.

Information about each music piece is stored in the second database 300.

In an embodiment, the title and the copyright owner's name of each music piece are stored in the second database 300.

The server obtains detailed information about the copyright owner from the first database 200 by using the copyright owner's name of the second database 300. An identifier for obtaining the copyright owner information stored in the first database 200 is stored in the second database 300.

In another embodiment, the copyright owner information obtained from the first database 200 is stored in the second database 300.

Information about each music content is stored in the third database 400.

In an embodiment, the title, the recording information, the publication information, and the performer's name of each music content are stored in the third database 400.

The server obtains music piece information from the second database 300 by using the title of each music content stored in the third database 400. Furthermore, the server obtains the copyright owner information from the first database 200, which is linked to the music piece information stored in the second database 300. An identifier obtaining the music piece information stored in the second database 300 is stored in the third database 400.

In another embodiment, the music piece information obtained from the second database 300 and the copyright owner information obtained from the first database 200 may be stored in the third database 400.

The server obtains performer information from the first database 200 by using the performer's name of each music content stored in the third database 400. An identifier obtaining the performer information stored in the first database 200 is stored in the third database 400.

In another embodiment, the copyright owner information obtained from the first database 200 is stored in the third database 400.

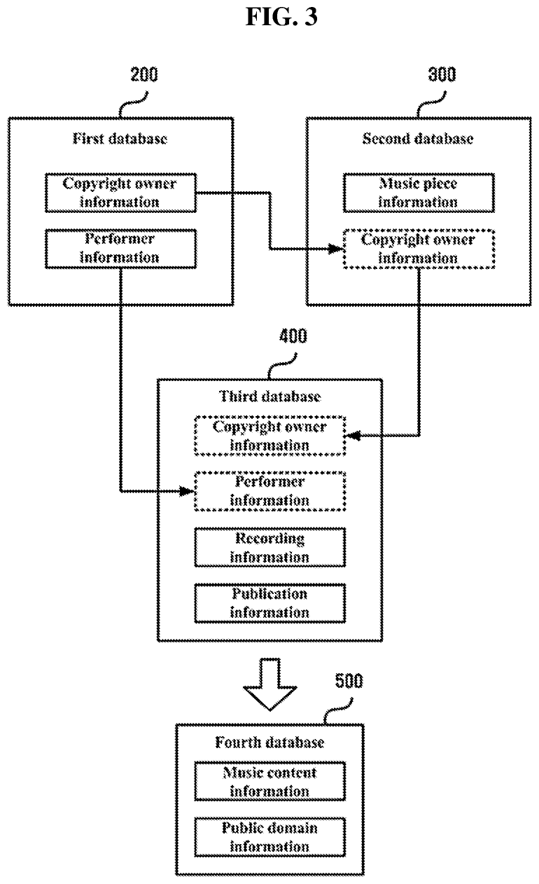

FIG. 3 is a view additionally illustrating a fourth database, according to an embodiment.

In an embodiment, a server generates a fourth database 500 storing information about each music content stored in the third database 400 and information about whether each music content is a public domain.

The information about whether each music content is the public domain is stored in the fourth database 500. Accordingly, when a request for determination about whether each music content is the public domain, the server determines whether each music content is the public domain, by searching the fourth database 500.

In an embodiment, pieces of information for determining whether each music content is the public domain are further stored in the fourth database 500. For example, copyright owner information, performer information, recording information, publication information, and the like of each music content are stored in the fourth database 500.

The server determines whether each music content is the public domain, based on Copyright Law and International Treaty.

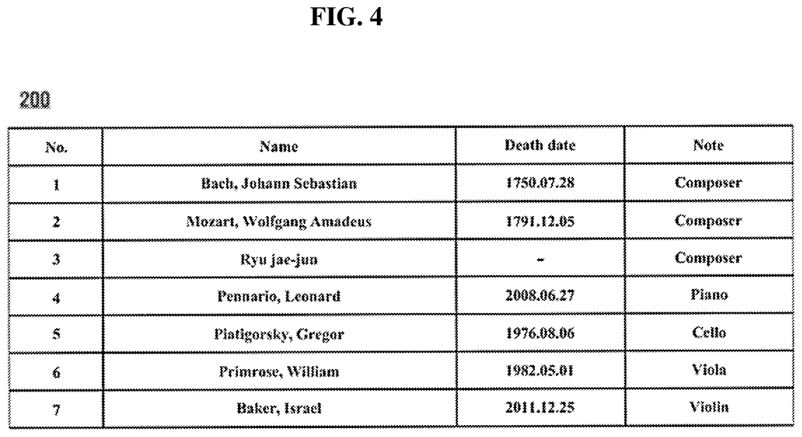

Hereinafter, the detailed method in which the server determines whether each music content is the public domain will be described by using the exemplification illustrated in FIGS. 4 to 7. In the disclosed embodiment, the method for determining whether each music content is the public domain, depending on a rule set arbitrarily will be described. However, this is provided as an example, and the detailed method may be changed depending on the time and the country to each of which the disclosed embodiment is applied.

FIG. 4 is a table illustrating an example of a first database.

Information about a copyright owner or a performer is stored in the first database 200. According to the disclosed embodiment, the name of each copyright owner or each performer, a death date, a field of activity, and the unique number of each copyright owner or each performer are stored in the first database 200.

In an embodiment, a server converts the death date of each copyright owner or each performer into a number to calculate whether the copyright or the neighboring right of each copyright owner or each performer expire. For example, the server converts the death date of each copyright owner or each performer into the number depending on the rule shown in Table 1 below.

TABLE 1

| Description | Data | Conversion | Data name |
|---|---|---|---|
| Converting year information | 1750.7.28 | 1750 | author_death |
| into a number | | | perform_death |
| Converting into ‘9999’, | NULL | 9999 | |
| when someone is alive or | | | |
| when there is no information. | | | |
| Substituting the highest | 198X | 1989 | |
| number, when information | | | |
| is incorrect. | | | |

In Table 1, ‘data name’ is used to represent each converted number in the following expression.

The main activity field of each copyright owner or each performer is stored in field ‘Note’ of the first database 200. In another embodiment, one or more activity fields of each copyright owner or each performer are stored in the first database 200. However, the activity field of each copyright owner or each performer is not limited to the activity field stored in the first database 200.

For example, a composer may be a pianist at the same time; a performer may be a composer or a lyricist and may play a plurality of musical instruments. Accordingly, the field of activity of each copyright owner or each performer is not limited to the field of activity stored in the first database 200.

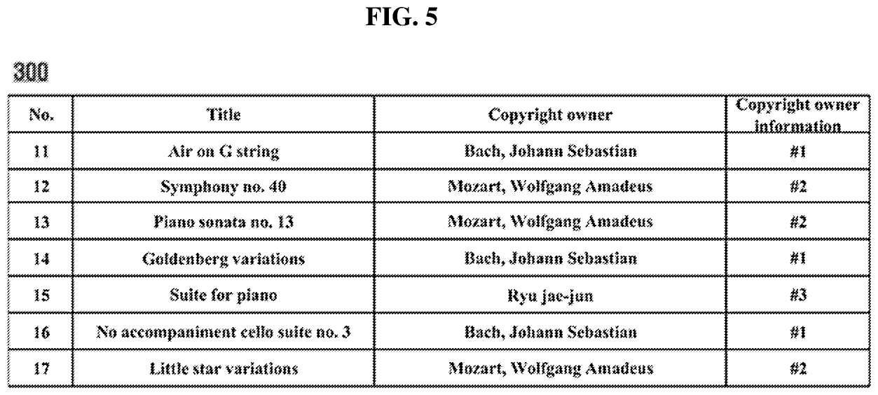

FIG. 5 is a table illustrating an example of a second database.

Information about a music piece is stored in the second database 300. According to the disclosed embodiment, the title of each music piece, the name of a copyright owner, and the unique number of each music piece are stored in the second database 300.

Furthermore, an identifier for obtaining copyright owner information of each music piece from the first database 200 is stored in the second database 300.

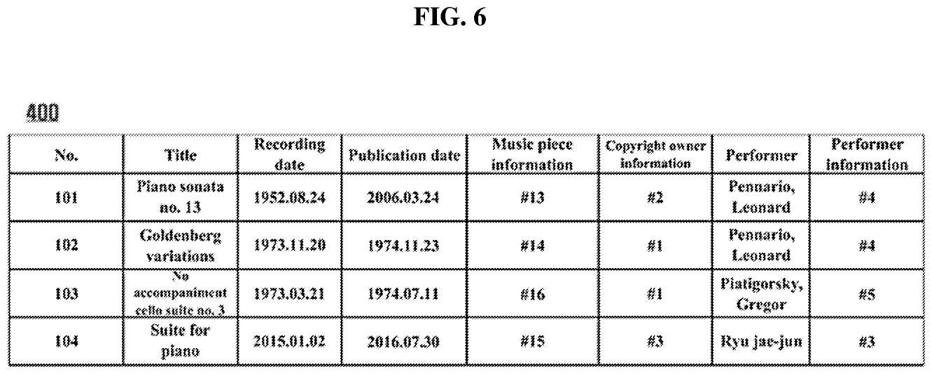

FIG. 6 is a table illustrating an example of a third database.

Information about music contents is stored in the third database 400. According to the disclosed embodiment, the title of each music content, the recording date of each music content, the publication date of each music content, the name of a performer of each music content, and the unique number of each music content are stored in the third database 400.

In addition, an identifier for respectively obtaining music piece information and copyright owner information, which correspond to each music content, from the second database 300 and the first database 200 is stored in the third database 400.

In an embodiment, a server converts each of the recording date or the publication date to a number to calculate whether a neighboring right expires. For example, the server converts each recording date or each publication date into the number depending on the rule shown in Table 2 below.

TABLE 2

| | | | Conversion | Conversion | Data |
|---|---|---|---|---|---|
| Classification | Description | Data | 1 (year) | 2 (date) | name |
| Recording | Converting year (month) | 1973.8.7 | 1973 | 197308 | rec_year |
| | information into a number. | | | | rec_date |
| | In the case of a plurality | 1954.8.30~9.2 | 1954 | 195409 | |
| | of periods, converting to | | | | |
| | the last date. | | | | |
| Publication | Converting year (month) | 1967.7.20 | 1967 | 196707 | publish_year |
| | information into a number. | | | | publish_date |
| | Converting to the last month, | 1980 | 1980 | 198012 | |
| | when there is no information | | | | |
| | other than a year. | | | | |

In Table 2, ‘data name’ is used to represent each converted number in the following expression.

In an embodiment, with respect to the country with 50-year duration of a copyright and a neighboring right, the server determines whether each music content is a public domain, in the manner shown in Table 3 below. The duration of each of the copyright and the neighboring right, whether the neighboring right is protected, or the like may be changed depending on the country, and Table 3 below is provided for exemplification.

TABLE 3

| The type of | | |
|---|---|---|
| copyright | Reasons of public domain | Example of expression |
| Copyright | 50 years have passed after | year(today( )) − 50 > |
| | copyright owner's death | author_death |
| Neighboring | 50 years have passed after | year(today( )) − 50 > |
| right | recording and publication | rec_year && |
| | | year(today( )) − 50 > |
| | | publish_year |

In the expression shown in Table 3, year(today( )) is a function indicating the year of the current day. ‘author_death’ indicates the year of death of the copyright owner, and ‘rec_year’ and ‘publish_year’ are defined in Table 1 and Table 2 above.

Likewise, in the expression shown in Table 3, ‘50’ may be converted to ‘70’, and then the converted result may be applied to the country with 70-year duration of a copyright and a neighboring right.

Furthermore, when further applying Korean Copyright Law, the server may determine whether to be a public domain, in the manner shown in Table 4 below.

When Copyright Law is applied, Domestic Copyright Law and International Treaty, and the transitional provision according to the amendment to each law and treaty need to be considered variously. In an embodiment, the server determines the transitional provision to be applied based on the recording date or the publication date of the music contents.

TABLE 4

| The type of | | |
|---|---|---|
| copyright | Reasons of public domain | Example of expression |
| pd_copyright_kor | The work of a copyright owner who died | author_death < 1963 |
| (Copyright) | before 1962. The copyright has expired. | |
| pd_neighboring_kor | An oversea music record that was published | rec_year < |
| (Neighboring right) | before Mar. 31, 2009, on which 50 years have | year(today( )) − 50 && |
| | passed after recording. The neighboring right | publish_date < 200903 |
| | has expired. | |
| | An oversea music record, which was published | publish_year < 1983 |
| | before Dec. 31, 1982 and of which the performer | && perform_death < |
| | died. The neighboring right has expired. | 1983 |
| | An oversea music record, which was recorded | rec_date < 198707 && |
| | before Jun. 30, 1987 and which was published | publish_date > 198706 |
| | from Jul. 1, 1987 to Jun. 28, 2007. The | && publish_date < |
| | neighboring right has expired. | 200706 |
| | An American music record, which was published | publish_year < 1983 |
| | before Dec. 31, 1982 and which was recorded | && rec_date < 197202 |
| | before Feb.14, 1972. The neighboring right | |
| | has expired. | |

Each piece of data included in the expression in Table 4 is defined in Table 1 and Table 2.

The reasons of public domains displayed in Table 4 are described based on Korean Copyright Law at the time of filing and the convention to which the Republic of Korea is affiliated, but this is only provided as an example.

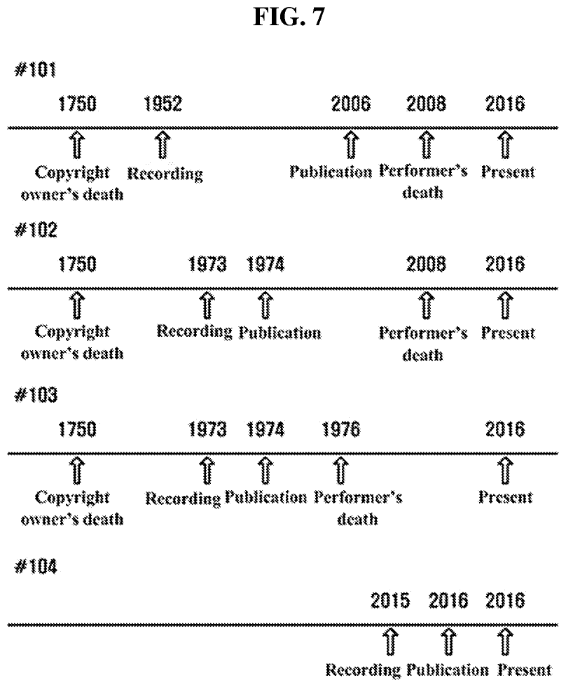

FIG. 7 is a view illustrating a method for determining whether each music content is a public domain, according to a disclosed embodiment.

Referring to FIG. 7, a time table for determining whether four music contents included in the third database are public domains is illustrated.

With regard to No. 101 music contents of the third database, a server obtains information about a music piece and identifier #2 of copyright owner information from the second database through music piece information identifier #13 and obtains information about the copyright owner by using identifier #2 of copyright owner information. Furthermore, the server obtains information about the performer by using identifier #4 of the performer information.

The server determines whether No. 101 music content is a public domain, by using the obtained pieces of information and pieces of information stored in the third database.

In the case of No. 101 music content, since the copyright owner died in 1750, the copyright has expired. In the case of the neighboring right, since fifty years have passed since the recording was made and the publication is made before Mar. 18, 2009, the neighboring right has expired and thus No. 101 music content corresponds to the public domain.

The server determines whether the remaining music contents are public domains, in the same manner.

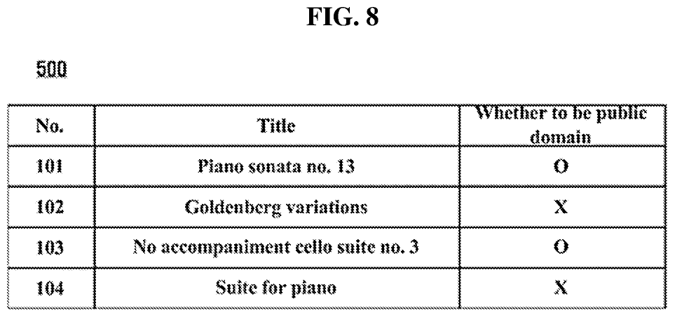

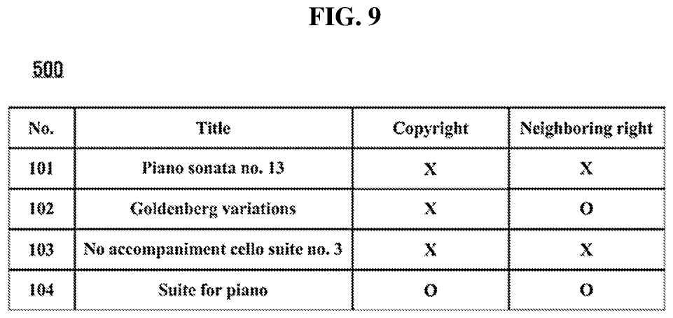

The exemplification of a fourth database storing whether the copyright or the neighboring right of each music content expire and whether to be a public domain is illustrated in FIGS. 8 and 9.

In the case of No. 102 music content, since the copyright owner died in 1750, the copyright has expired. On the other hand, since No. 102 music content does not correspond to the expiration of the neighboring right, No. 102 music content is not a public domain.

In the case of No. 103 music content, since the copyright owner died in 1750, the copyright has expired. Also, since No. 103 music content was published before 1982 and the performer died before 1982, the neighboring right has expired and thus No. 103 music content corresponds to the public domain.

In the case of No. 104 music content, since the copyright owner is alive, the copyright has not expired. Likewise, since the neighboring right does not expire, No. 104 music content does not correspond to the public domain.

The server determines whether the music contents stored in the third database are public domains, through the above process. In addition, the server stores whether the music contents stored in the third database are public domains, in the fourth database.

In some embodiments, the above-discussed method of FIG. 1, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 1 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to a disclosed embodiment, it is possible to automatically provide whether the copyright of each copyrighted work has expired, by using a relational database.

In particular, it is possible only to add information to each database by using the relational database, and thus information about whether the copyright of each copyrighted work has expired is updated, together.

Accordingly, it is possible to get a profit, by easily providing a service using public domains, the copyright of each of which has expired.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for managing a copyright of music content performed by a server, comprising:
storing information about a name or a death date of each of a copyright owner and a performer in a first database as information about one or more copyright owners and performers;
storing information about a title and the name of the copyright owner of a music piece in a second database, as information about one or more music pieces;
storing information about the name of the performer, a recording time, a publication time, a published country of the music content in a third database as information about one or more music contents;
matching information about the one or more copyright owners stored in the first database with the one or more music pieces stored in the second database, matching information about the one or more music pieces stored in the second database with the one or more music contents stored in the third database, and matching information about the one or more music contents stored in the third database with information about the one or more performers stored in the first database;
receiving selection information about first music content stored in the third database;
obtaining information about a music piece matched with the first music content from the second database and obtaining information about the copyright owner matched with the music piece from the first database;
providing information about the copyright owner or information about the performer;
storing the information about the one or more music contents stored in the third database and information about whether each music content is a public domain in a fourth database; and
providing information about a remaining time until the first music content becomes the public domain, when the first music content is not the public domain,
wherein the providing of the information includes:
obtaining a duration of a posthumous copyright of the copyright owner and a duration of a posthumous neighboring right of the performer depending on a transitional provision of Copyright Law and International Treaty, determining the transitional provision to be applied to the first music content depending on a recording time or a publication time of the first music content;
determining whether the first music content is the public domain, depending on a death date of each of the copyright owner and the performer, the obtained duration of the copyright, and the obtained duration of the neighboring right, determining whether the first music content is the public domain, depending on a recording time and a publication time of the first music content and the transitional provision; and
providing information about whether the first music content is the public domain, which is stored in the fourth database,
wherein the determining of whether the first music content is the public domain includes:
determining whether the first music content is the public domain, depending on the duration of the copyright and the neighboring right of a country to be applied,
wherein the matching further includes:
storing a first identifier in the second database and storing a second identifier in the third database; and
storing a third identifier in the third database,
wherein the first identifier is used to obtain information about the one or more copyright owners matched with the one or more music pieces stored in the second database from the first database,
wherein the second identifier is used to obtain information about the one or more music pieces matched with the one or more music contents stored in the third database from the second database,
wherein the third identifier is used to obtain information about the one or more performers matched with the one or more music contents stored in the third database from the first database, and
wherein the server is configured to:
convert a death date of each copyright owner or each performer into a number to store the converted number in the first database for the purpose of calculating whether the copyright or the neighboring right of each copyright owner or each performer expires, wherein the death year is converted into ‘9999’ and stored when the copyright owner or the performer is alive or there is no information, and wherein a unit's place of the death year is substituted and stored with ‘9’, when the unit's place of the death year is incorrect; and
convert each recording date or each publication date into a number to store the converted number in the third database for the purpose of calculating whether the neighboring right has expired, wherein a recording date or a publication date is converted and stored into a last date, when the recording date or the publication date has a plurality of periods, and wherein the recording date or the publication date is converted and stored into a last month, when there is no information other than a year.
